(19) United States
(12) Patent Application Publication
(10) Pub. No.: US 2023/0316351 A1
(43) Pub. Date: Oct. 5, 2023

(54) UNMANNED AUTOMATED NON-FACE-TO-FACE PRODUCT SALES SYSTEM WITH OCCUPANCY SPACE-OPTIMIZED DESIGN

(71) Applicant: Sanghoon LEE, Busan (KR)

(72) Inventor: Sanghoon LEE, Busan (KR)

(21) Appl. No.: 18/187,495

(22) Filed: Mar. 21, 2023

(30) Foreign Application Priority Data
Mar. 29, 2022 (KR) 10-2022-0038767

(51) Int. Cl. G06Q 30/0601

(52) U.S. Cl. CPC G06Q 30/0601

(57) ABSTRACT

The present invention relates to an unmanned automated non-face-to-face product sales system with occupancy space-optimized design, and more particularly, to a technology in which stores such as convenience stores and supermarkets have a problem that high rents are charged due to locational restrictions, but the rent burden of business operators is minimized through dualization of places, and a new type of unmanned system is applied to thereby enhance the effect of reducing the labor costs for business operators while increasing consumer satisfaction. That is, the product sales system of the present invention includes: a product purchasing place, a product storage, a product transfer device, a management server, and a business operator terminal.

### TECHNICAL FIELD

The present invention relates to an unmanned automated non-face-to-face product sales system with occupancy space-optimized design, and more particularly, to a technology in which stores such as convenience stores and supermarkets have a problem that high rents are charged due to locational restrictions, but the rent burden of business operators is minimized through dualization of places, and a new type of unmanned system is applied to thereby enhance the effect of reducing the labor costs for business operators while increasing consumer satisfaction.

### BACKGROUND ART

In general, convenience stores and supermarkets are shops that are disposed in various places, and correspond to places where various products such as various daily necessities, snacks, ramen, beverages, instant foods, food materials, and medicines are sold. The stores operating 24 hours a day, mainly in places that are easily accessible to consumers, is increasing.

Such convenience stores are located on the first floor with the highest rent in the building to increase consumer accessibility, and occupy a large area to store various products. This causes the high rent, and due to the fixed expenditure of such rent, the income of the store owner has no choice but to decrease.

In addition, since convenience stores and supermarkets that operate 24 hours a day must always have staff residing in the store to settle payment for consumer products and organize and manage products, the labor costs for the staff inevitably increase the burden on store owners.

As an alternative to this, in recent years, the unmanned shops are increasing, thus reducing labor costs. Due to the characteristics of convenience stores and supermarkets, however, in order to make smooth profits, they must be applied to places that require high rent, and cannot greatly settle the burden on the store owner, which causes other problems such as various theft problems, product procurement problems, and occupation problems by drunken people and students.

As one example of the related prior art, Korean Patent No. 10-2061423 discloses an unmanned convenience store monitoring system which comprises: an entrance controller which notifies an unmanned operation of a convenience store when sensing access of a customer in a late-night time, and controls an entrance door when a user authentication is completed through an authentication means; an unmanned counter which supports a customer to pay money for purchased goods by himself or herself; a guiding display panel which provides a help button for helping the use of the convenience store, and when a customer selects the help button, is connected to a manager terminal of an operating server to provide a video call service between the customer and a manager; a capturing means which provides an image capturing the inside of the convenience store; a monitoring means which detects objects in the image and outputs an alarm signal if the detected object has no motion for a set time; an alarm means which outputs a warning sound or a message in correspondence to the alarm signal; and a communication unit which is connected to the operating server via a network and transmits the image or the alarm signal to the operating server.

The above prior art is a technology that detects the movement of customers entering the store and notifies a manager or a store owner when there is no movement, which is a technique for coping with various accident problems and homelessness problems in the store. In addition, the above prior art is simply a technology for unmanning sales staff residing in convenience stores, which correspond to a technology that fails to solve the fundamental problems (e.g., high rent due to location with high consumer accessibility) caused by the locational restrictions of convenience stores described above.

Therefore, in order to operate such an unmanned convenience store, it must operate on a smaller scale than the existing convenience store, so that the burden of the store owner can be reduced to some extent.

In addition, since most of the prior arts related to unmanned convenience stores use vending machines, the types of products are very limited, which causes a problem that various products cannot be sold, and the quantity of products is also limited to the extent to which the vending machine can accommodate. Therefore, when a specific product is out of stock, there is a problem that the out-of-stock state continues, and consumers cannot purchase the product they want, reducing their purchase desire.

### PRIOR ART LITERATURE

### Patent Literature

(Patent Literature 0001) Korean Patent No. 10-2061423 (title: Unmanned convenience store monitoring system)

(Patent Literature 0001) Korean Unexamined Patent Publication No. 10-2020-0008809 (title: Unmanned convenience store system and commodity transaction method using the unmanned convenience store system)

### DETAILED DESCRIPTION OF THE INVENTION

### Technical Problem

The present invention has been devised to solve the above-mentioned problems, and therefore, an object of the present invention is to provide an unmanned automated non-face-to-face product sales system with occupancy space-optimized design, which not only enables payment for products selected by consumers and provision of the products without using manpower while having no sales staff residing in convenience stores and supermarkets, thus reducing labor costs and improving accessibility for consumers, but also can apply a portion where the products are stored to a place where the rent is cheap, thus increasing the profitability of the store owner.

### Technical Solution

According to the present invention, there is provided an unmanned automated non-face-to-face product sales system with occupancy space-optimized design, the system comprising: a product purchasing place that performs product selection and payment function through a kiosk located and installed at the height of the first floor so as to facilitate consumer access, and then directly receives the purchased products, a product storage that is provided in a space separate from the kiosk and the product purchasing place, is located in a place that is difficult to access and has a lower rent than the place of the product purchasing place, for example, is located in a basement or two or higher floors above the ground, and stores products that can order at the kiosk, a product transfer device that moves the same product stored in the product storage to the product purchasing place in accordance with product information purchased through the kiosk of the product purchasing place, a management server that registers and manages product information stored in the product storage and manages payment information of the product purchasing place, and a business operator terminal that receive sales information of the product purchasing place from the management server.

Further, the product purchasing place is provided in the form of an outdoor booth separate from a building.

Further, the product purchasing place comprises an input/output unit that displays product information of products and selects a product to be purchased, a payment processing unit that performs payment for the selected product, a first communication unit that transmits product information selected through the input/output unit to the product storage and transmits payment information to the management server, a first information storage unit that stores detailed information, stock quantity, price, expiration date, and discount information of products sold from the management server, and a product discharging unit that is formed so that the product paid through the payment processing unit is provided through the product transfer device to thereby be received by the consumer.

The product discharging unit is in the form of an openable/closable door to block the inflow of foreign matter.

Further, the product storage comprises a product storage unit that stores products in accordance with their types in a certain space, a product scanner unit that recognizes product information placed in the product storage unit in the form of a barcode or an IO code, a second information storage unit that stores product information scanned through the product scanner unit, and a second communication unit that receives product information selected by the product purchasing place and transmits the product information to the product transfer device.

Further, the product transfer device comprises a transfer path that is provided in the form of connecting the product purchasing place and the product storage, a transport cage that can reciprocate along the transport path and temporarily stores the purchased products, and a finger unit that moves the product selected at the product purchasing place into the space of the transfer cage.

Further, the unmanned automated non-face-to-face product sales system with occupancy space-optimized design further comprises a first camera unit for photographing the product purchasing place, a second camera unit for photographing the product storage, and a third camera unit for photographing the product transport device, wherein real-time image information of the first camera unit, the second camera unit and the third camera unit is transmitted to the management server.

Further, the management server comprises a DB storage unit that stores product information registered in each product storage, payment information, sales information, business operator information, and customer information, and a third communication unit that receives registered product information via the product storage, transmits and displays the registered product information to the product purchasing place, transmits and receives payment information, and provides sales information to the business operator terminal.

Further, the business operator terminal can check and manage the overall status of the unmanned automated non-face-to-face product sales system through the third communication unit, and can request product ordering.

Further, the product storage is composed of a single unit, and a plurality of product purchasing places sharing the product storage are provided, so that respective product purchasing places are connected through respective independent product transfer devices.

### Advantageous Effects

The present invention has an effect of enabling payment for products selected by consumers and provision of the products without using manpower while having no sales staff residing in convenience stores and supermarkets, thus reducing labor costs.

Also, according to the present invention, consumers' product purchases are applied to the minimum area in a portion where the rent is high, and places where large quantity of products are stored occupy a large area in a portion where the rent is relatively low, thus increasing consumer accessibility and minimizing the rent burden of business operators.

Moreover, since the product purchase place is operated with a minimum area, it is possible to prevent occurrence of unauthorized occupation by drunken people, homeless people, and students, and the storage place of products is located in a place where it is difficult for people to access, so that the problem of theft can be prevented.

In addition, according to the present invention, the types of products are more diverse and the quantity of products is sufficient as compared to the existing vending machine-style unmanned convenience stores, whereby there is the advantage that it is possible to increase consumer satisfaction and easily check information on a product to be purchased through a kiosk.

### BRIEF DESCRIPTION OF THE DRAWINGS

FIG. 1 is a schematic diagram which schematically shows an unmanned automated non-face-to-face product sales system of the present invention.

FIG. 2 is a configuration diagram which specifically expresses the unmanned automated non-face-to-face product sales system of the present invention.

FIG. 3 is a diagram which shows an application example of a product transport device constituting the unmanned automated non-face-to-face product sales system of the present invention.

FIG. 4 is a diagram which shows another embodiment of a product transport device constituting the unmanned automated non-face-to-face product sales system of the present invention.

FIG. 5 is a diagram which shows another embodiment further including first, second, and third camera units in the unmanned automated non-face-to-face product sales system of the present invention.

FIG. 6 is a diagram which shows yet another embodiment of operating a plurality of product purchasing places in the unmanned automated non-face-to-face product sales system of the present invention.

### DETAILED DESCRIPTION OF THE EMBODIMENTS

Preferred embodiments of the present invention will be described in detail below with reference to the accompanying drawings. In the following description of the present invention, a detailed description of known related functions and configurations will be omitted when it is determined when the detailed description may unnecessarily make the gist of the present invention unclear.

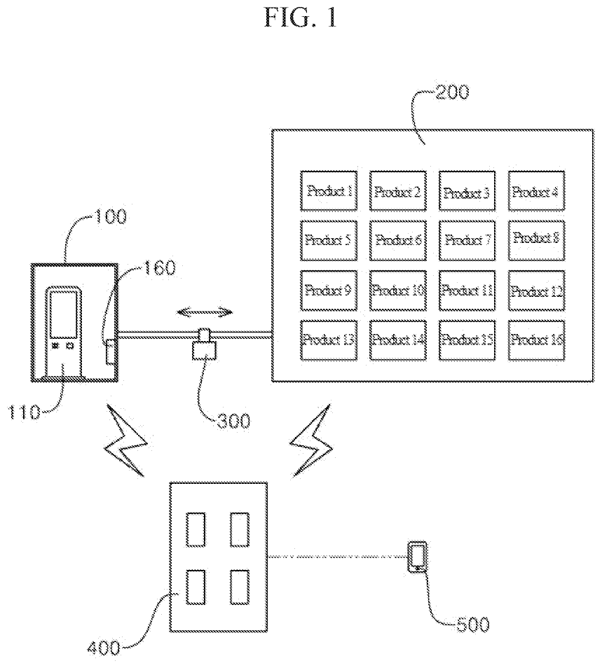

As shown in FIG. 1, the present invention provides an unmanned automated non-face-to-face product sales system with occupancy space-optimized design, the system comprising: a product purchasing place 100 that performs product selection and payment function through a kiosk 110 located and installed at the height of the first floor so as to facilitate consumer access, and then directly receives the purchased products, a product storage 200 that is provided in a space separate from the product purchasing place 100, is located in a place that is difficult to access and has a lower rent than the place of the product purchasing place 100, and stores products that can order at the kiosk 110, a product transfer device 300 that moves the same product stored in the product storage 200 to the product purchasing place 100 in accordance with product information purchased through the kiosk 110 of the product purchasing place 100, a management server 400 that registers and manages product information stored in the product storage 200 and manages payment information of the product purchasing place 100, and a business operator terminal 500 that receive sales information of the product purchasing place 100 from the management server 400.

A feature of the present invention is that a product purchasing place 100 corresponding to a place where consumers directly purchase products and receive purchased products, and a product storage 200 in which a large quantity of products are actually stored are formed independently, and reduction in the rent can be maximized through the product transfer device 300 connecting them.

The product purchasing place 100 is located on the first floor so as to facilitate consumer access, and has only a kiosk 110 and is only configured to receive products, and does not store actual products. Therefore, even if the area used is small, sufficient operation is possible. That is, the product purchasing place 100 can minimize the rent due to a small area even on the first floor where the rent is the highest among the shopping area. In addition, since it is operated with a minimum area, it is possible to prevent occurrence of unauthorized occupation by drunken people, homeless people, and students.

In addition, the product purchasing place 100 can be applied in the form of a shopping area in a building, but when installed in the form of an outdoor booth separate from the building, it is possible to further reduce the rent while increasing consumer accessibility.

The product storage 200 of the present invention is applied to a space separate from the product purchasing place 100, and is located in a basement or second floor or higher, where consumer access is difficult and the rent is low, contrary to the product purchasing place 100. The product storage 200 is configured to occupy the largest area, and is located in a place where rent is cheaper than before, so that the rent can be reduced, and problems such as theft can be prevented because people's accessibility is low.

In addition, the product storage 200 can be applied to a commercial building, but it is separately configured as a prefabricated building in the form of a warehouse in a place close to the product purchasing place 100, thereby reducing construction costs and operating costs.

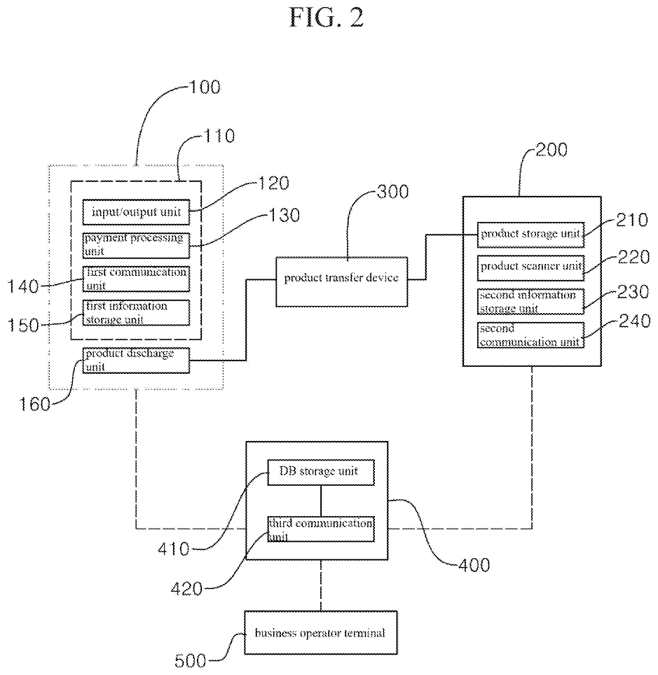

As shown in FIG. 2, the product purchasing place 100 according to the present invention comprises an input/output unit 120 that displays product information of products and selects a product to be purchased, a payment processing unit 130 that performs payment for the selected product, a first communication unit 140 that transmits product information selected through the input/output unit 120 to the product storage 200 and transmits payment information to the management server 400, a first information storage unit 150 that stores detailed information, stock quantity, price, expiration date, and discount information of products sold from the management server 400, and a product discharging unit 160 that is formed so that the product paid through the payment processing unit 130 is provided through the product transfer device 300 to thereby be received by the consumer.

The input/output unit 120 is configured to operate by a touch screen of the kiosk 110, and when various purchasable products are displayed on the screen, and a product to be purchased is selected and inputted among the output products, payment is performed through the payment processing unit 130 using cash or a simple payment system such as a card or mobile phone.

Further, information about the product such as which product is selected through the input/output unit 120 is transmitted to the product storage 200 via the first communication unit 140. The payment information is then transmitted to the management server 400. Further, the first information storage unit 150 stores various information provided from the management server 400, and stores detailed information, stock quantity, price, expiration date, and discount information of products to be sold.

Therefore, discount information on a specific product can be provided through the input/output unit 120, and it is also possible to self-apply a discount considering the stock quantity and distribution period of the products which are currently in the product storage 200.

The product discharge unit 160 is configured to receive purchased products and is formed inside the product purchasing place 100. The product discharge unit 160 moves the product, for which payment has been completed through the payment processing unit 130, from the product storage 200 to the product purchasing place 100 via the product transfer device 300, so that the consumer can receive the purchased product. The product discharge unit 160 is preferably in the form of openable and closable door to block the inflow of foreign matter. More preferably, it is possible to set the lock electronically so that it is temporarily opened only when a product is received, and thus, the external foreign matter can be blocked more actively.

As shown in FIG. 2, the product storage 200 according to the present invention comprises a product storage unit 210 that stores products in accordance with their types in a certain space, a product scanner unit 220 that recognizes product information placed in the product storage unit 210 in the form of a barcode or an IO code, a second information storage unit 230 that stores product information scanned through the product scanner unit 220, and a second communication unit 240 that receives product information selected by the product purchasing place 100 and transmits the product information to the product transfer device 300.

The product storage unit 210 refers to an entire space in which various products are stored. Preferably, the entire space of the product storage unit 210 is again classified according to the type of each product, and the location is designated for each product. Further, the product scanner unit 220 is configured to input product information when a product provided by a supplier of a sales product is placed in the product storage unit 210. At this time, the product information is recognized in the form of a barcode or QR cord, and people can directly scan the product, but preferably, it is composed of a conveyor device and a scanner device installed at the upper part of the conveyor device to automatically recognize a product, so that the product information can be easily input without the need for people to scan one by one.

The second information storage unit 230 stores product information scanned through the product scanner unit 220. Through the product information stored in the second information storage unit 230 in this way, it is possible to accurately record the type, quantity, expiration date and the like of products which are currently in the product storage 200, and this is grasped in real time, so that consumers can grasp the types of products available for purchase and whether or not the product is out of stock. Business operators who manage unmanned stores will be able to accurately grasp inventory management.

The second communication unit 240 can communicate with the product transfer device 300 and the management server 400, and transmits information on the purchased product so that the purchased product can be accurately transferred to the product transfer device 300, and the information stored in the second information storage unit 230 is provided to the management server 400, so that the business operator can receive information on the inventory status of the product, while transmitting accurate information to the kiosk 110 of the product purchasing place 100.

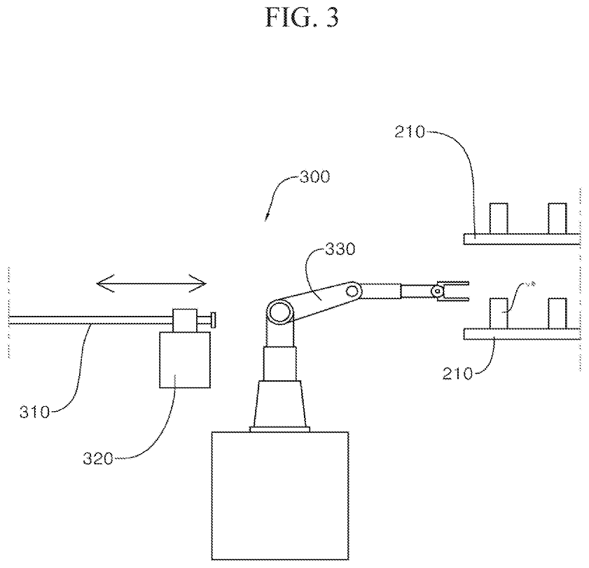

The product transfer device 300 of the present invention is configured to receive the product purchased by the consumer accurately and safely, and as shown in FIG. 3 as a preferred example, the product transfer device 300 comprises a transfer path 310 that is provided in the form of connecting the product purchasing place 100 and the product storage 200, a transport cage 320 that can reciprocate along the transport path 310 and temporarily stores the purchased products, and a finger unit 330 that moves the product selected at the product purchasing place 100 into the space of the transfer cage 320.

The transfer path 310 is a path through which the transfer cage 320 can reciprocate, and is provided in the form of connecting the product purchasing place 100 and the product storage 200. At this time, the transfer path 310 is provided horizontally on the figure, but it can be provided in various forms in consideration of the movement path between the product purchasing place 100 and the product storage 200. That is, it may be provided in a vertical direction, or may be provided in a mixture of vertical and horizontal directions, or may be provided in a diagonally inclined direction.

The transfer cage 320 is configured to move along the transfer path 310 and is configured to temporarily store purchased products. That is, it may further include a drive device such as a motor and a wheel rotated by the drive device so as to move by itself along the transfer path 310. Further, a cushioning material is further attached to the inside of the transfer cage 320 to prevent breakage of fragile glass products when they fall down.

The finger unit 330 is configured to pick up a specific product from the product storage unit 210 in accordance with the purchased product and move it into the space of the transfer cage 320. The finger unit 330 not only has the function of transferring purchased products, but can also perform the operation of transferring new products provided from supplier to the product storage unit 210.

In addition, the finger unit 330 can perform product scanning in the form of interlocking with the product scanner unit 220 to pick up a product and directly bring it to the product scanner unit 220. In the case of this configuration, even when moving a new product to the product storage unit 210, the product can be picked up and registered through the product scanner unit 220. With respect to the purchased product, the product in the product storage unit 210 is picked up, and the paid product is registered in the product scanner unit 220, and then the product is put into the transfer cage 320, so that product inventory management is performed accurately.

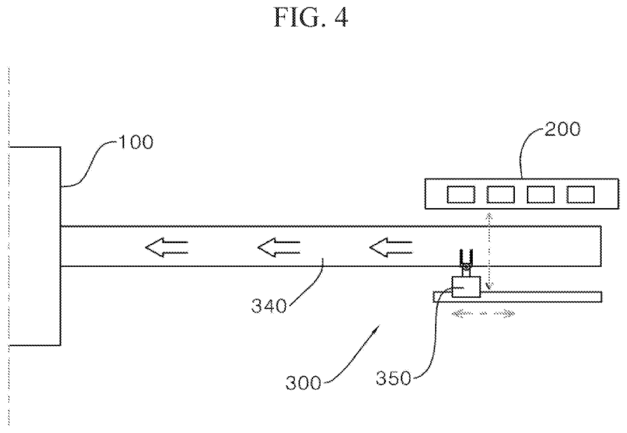

FIG. 4 shows yet another embodiment of a product transport device 300 according to the present invention, which comprises a conveyor 340 installed in a form of connecting the product purchase place 100 and the product storage 200, and a product selection and supply unit 350 installed at the product purchasing place 200 to move the purchased product to the upper part of the conveyor 340.

In the case of the embodiment of FIG. 3 described above, it is a method of moving along the transfer path 310 determined by the self-driving force of the transfer cage 320, while in the case of the embodiment of FIG. 4, it is a method in which purchased products are placed on the upper part of a conveyor 340 having a unidirectional product movement path. When a conveyor 340 type is applied, since the product is exposed as it is on the upper part of the conveyor 340, it is preferable to further provide a cover (not shown) that may be installed in the form of being buried underground or may be installed on the ground but that can protect the conveyor 340 in a form that wraps it.

Further, the product selection supply unit 350 is a mechanical device that picks up products to be moved and moves them to the upper part of the conveyor 340, and can be configured in such a way that it is movable in the X, Y and Z axes, and can pick up or put down products.

The product transfer device 300 of the present invention configured in this way can also be in the form of transferring the purchased product from the product storage 200 to the consumer of the product purchase place 100, but if there is a change of heart or a problem with the received product, the returned product can also be moved from the product purchasing place 100 to the product storage 200 in the reverse direction for the purpose of return.

The management server 400 of the present invention is configured to integrally manage information of all connected product purchasing places 200. Specifically, as shown in FIG. 2, the management server 400 comprises a DB storage unit 410 that stores product information, payment information, sales information, business operator information, and customer information registered in each product storage 200, and a third communication unit 420 that receives registered product information via the product storage 200, transmits and displays the registered product information to the product purchasing place 100, transmits and receives payment information, and provides sales information to the business operator terminal 500.

The DB storage unit 410 is configured to store product information, payment information, sales information, business operator information, and customer information registered in each product storage 200, wherein the product information receives the provision of data of the second information storage unit 230 of the product storage 200 via the second communication unit 240. Further, the payment information and sales information provide the paid information through the product purchasing place 100 and receive the provision through the first communication unit 140. Further, the business operator information stores information of business operators who operate the product storage 200 and product purchase center 100, and may provide information on sales and information on various operations to the relevant business operator terminal 500 based on the stored information.

The third communication unit 420 is configured to communicate with the product storage 200, the product purchasing place 100, and the business operator terminal 500, and receives product information registered in the product purchasing place 200, stores it in the DB storage unit 410, provides it to the product purchasing place 100, and displays purchasable products on the kiosk 110. Further, this receives the information paid through the kiosk 110, so that payment approval is made, the amount paid is calculated, and sales information is confirmed through the business operator terminal 500.

Further, the business operator terminal 500 checks and manages the overall status of the unmanned automated non-face-to-face product sales system using the information provided through the third communication unit 420 as an application installed in the business operator terminal 500, and requests product ordering to enable remote operation.

In the present invention made as described above, since the types of products are more diverse and the quantity of products is sufficient compared to the conventional unmanned convenience store of the vending machine method, there is an advantage that consumer satisfaction can be increased, and product information to be purchased through the kiosk 110 can be easily confirmed.

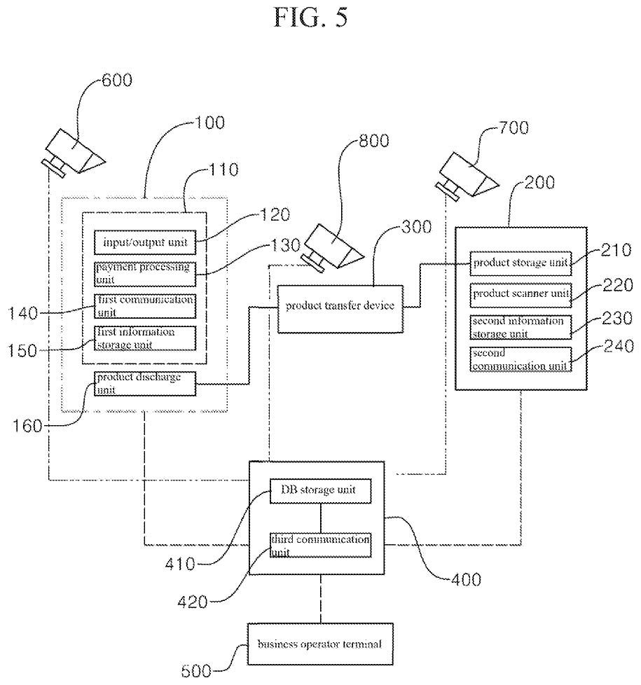

FIG. 5 shows an unmanned automated non-face-to-face product sales system according to another embodiment of the present invention, which further comprises a first camera unit 600 for photographing the product purchasing place 100, a second camera unit 700 for photographing the product storage 200, and a third camera unit 800 for photographing the product transport device 300, wherein real-time image information of the first camera unit 600, the second camera unit 700 and the third camera unit 800 is transmitted to the management server 400.

As described above, the images captured in real time through the first camera unit 600, the second camera unit 700, and the third camera unit 800 are transmitted to the management server 400, whereby there is the advantage that the store owner can directly monitor the status of the product purchasing place 100, product storage 200, and product transfer device 300 in real time through the business operator terminal 500 communicating therewith, and it is possible to take appropriate measures when various problems occur.

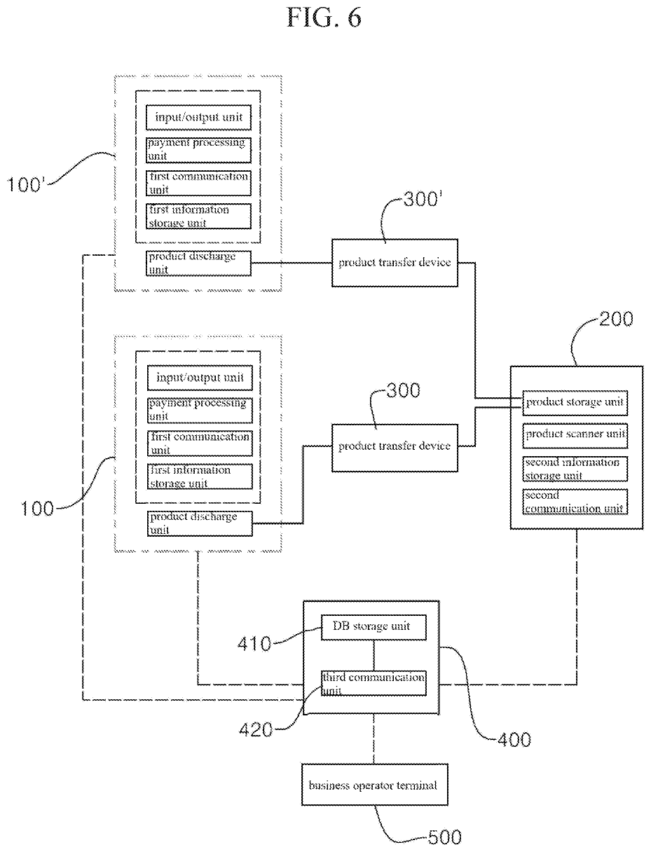

FIG. 6 shows another embodiment of the present invention, wherein the product storage 200 is composed of a single unit, and a plurality of product purchasing places 100 and 100′ sharing the product storage 200 are provided, so that respective product purchasing places 100 and 100′ are connected through respective independent product transfer devices 300 and 300′.

When a plurality of product purchasing places 100 and 100′ are integrally operated in one product purchasing place 200 in this way, sales efficiency can be further increased and sales can be improved, and the burden of rent is further reduced.

Although the present invention has been described above with reference to the embodiments, it will be apparent to those skilled in the art that various modifications can be carried out within the scope of the technical idea of the present invention.

Description of Reference Numerals

| | |
|---|---|
| 100: Product purchasing place | 110: kiosk |
| 120: input/output unit | 130: payment processing unit |
| 140: first communication unit | 150: first information storage unit |
| 160: product discharge unit | 200: product storage |
| 210: product storage unit | 220: product scanner unit |
| 230: second information storage unit | 240: second communication unit |
| 300: product transfer device | 310: transfer path |
| 320: transfer cage | 330: finger unit |
| 340: conveyor | 350: product selection supply unit |
| 400: management server | 410: DB storage unit |
| 420: third communication unit | 500: business operator terminal |
| 600: first camera unit | 700: second camera unit |
| 800: third camera unit | |

1. An unmanned automated non-face-to-face product sales system with occupancy space-optimized design, the system comprising:
a product purchasing place 100 that performs product selection and payment function through a kiosk 110 located and installed at the height of the first floor so as to facilitate consumer access, and then directly receives the purchased products,
a product storage 200 that is provided in a space separate from the product purchasing place 100, is located in a place that is difficult to access and has a lower rent than the place of the product purchasing place 100, and stores products that can order at the kiosk 110,
a product transfer device 300 that moves the same product stored in the product storage 200 to the product purchasing place 100 in accordance with product information purchased through the kiosk 110 of the product purchasing place 100,
a management server 400 that registers and manages product information stored in the product storage 200 and manages payment information of the product purchasing place 100, and
a business operator terminal 500 that receive sales information of the product purchasing place 100 from the management server 400.

2. The unmanned automated non-face-to-face product sales system with occupancy space--optimized design according to claim 1, wherein:
the product purchasing place 100 is provided in the form of an outdoor booth separate from a building.

3. The unmanned automated non-face-to-face product sales system with occupancy space--optimized design according to claim 1, wherein:
the product purchasing place 100 comprises,
an input/output unit 120 that displays product information of products and selects a product to be purchased,
a payment processing unit 130 that performs payment for the selected product,
a first communication unit 140 that transmits product information selected through the input/output unit 120 to the product storage 200 and transmits payment information to the management server 400,
a first information storage unit 150 that stores detailed information, stock quantity, price, expiration date, and discount information of products sold from the management server 400, and
a product discharging unit 160 that is formed so that the product paid through the payment processing unit 130 is provided through the product transfer device 300 to thereby be received by the consumer.

4. The unmanned automated non-face-to-face product sales system with occupancy space-optimized design according to claim 3, wherein:
the product discharging unit 160 is in the form of an openable/closable door to block the inflow of foreign matter.

5. The unmanned automated non-face-to-face product sales system with occupancy space-optimized design according to claim 1, wherein:
the product storage 200 comprises,
a product storage unit 210 that stores products in accordance with their types in a certain space,
a product scanner unit 220 that recognizes product information placed in the product storage unit 210 in the form of a barcode or an IO code,
a second information storage unit 230 that stores product information scanned through the product scanner unit 220, and
a second communication unit 240 that receives product information selected by the product purchasing place 100 and transmits the product information to the product transfer device 300.

6. The unmanned automated non-face-to-face product sales system with occupancy space-optimized design according to claim 1, wherein:
the product transfer device 300 comprises,
a transfer path 310 that is provided in the form of connecting the product purchasing place 100 and the product storage 200,
a transport cage 320 that can reciprocate along the transport path 310 and temporarily stores the purchased products, and
a finger unit 330 that moves the product selected at the product purchasing place 100 into the space of the transfer cage 320.

7. The unmanned automated non-face-to-face product sales system with occupancy space-optimized design according to claim 1, further comprising:
a first camera unit 600 for photographing the product purchasing place 100, a second camera unit 700 for photographing the product storage 200, and a third camera unit 800 for photographing the product transport device 300, wherein real-time image information of the first camera unit 600, the second camera unit 700 and the third camera unit 800 is transmitted to the management server 400.

8. The unmanned automated non-face-to-face product sales system with occupancy space-optimized design according to claim 1, wherein:
the management server 400 comprises,
a DB storage unit 410 that stores product information, payment information, sales information, business operator information and customer information registered in each product storage 200, and
a third communication unit 420 that receives registered product information via the product storage 200, transmits and displays the registered product information to the product purchasing place 100, transmits and receives payment information, and provides sales information to the business operator terminal 500.

9. The unmanned automated non-face-to-face product sales system with occupancy space-optimized design according to claim 8, wherein:
the business operator terminal 500 can check and manage the overall status of the unmanned automated non-face-to-face product sales system through the third communication unit 420, and can request product ordering.

10. The unmanned automated non-face-to-face product sales system with occupancy space-optimized design according to claim 1, wherein:
the product storage 200 is composed of a single unit, and a plurality of product purchasing places 100 and 100′ sharing the product storage 200 are provided, so that respective product purchasing places 100 and 100′ are connected through respective independent product transfer devices 300 and 300′.
